(19) United States
(12) Patent Application Publication
(10) Pub. No.: US 2008/0245067 A1
(43) Pub. Date: Oct. 9, 2008

(54) HYDROPNEUMATIC PRESSURE TRANSMISSION DEVICE

(75) Inventors: Eugen RAPP, Berg (DE); Bernd SCHAD, Ebersbach (DE); Peter WILHELM, Koln-Weiden (DE); Georg GERNERT, Kisslegg (DE)

Correspondence Address: BURR & BROWN, PO BOX 7068, SYRACUSE, NY, 13261-7068, US

(73) Assignee: Tox Pressotechnik GmbH & Co. KG, Weingarten (DE)

(21) Appl. No.: 12/052,184

(22) Filed: Mar. 20, 2008

(30) Foreign Application Priority Data
Mar. 26, 2007 (DE) 10 2007 014 910.9

(51) Int. Cl. F16D 31/06

(52) U.S. Cl. 60/494

(57) ABSTRACT

A hydropneumatic pressure transmission device having a working piston and a transmitter piston for pressure transmission to the working piston is proposed, with the working piston being guided in a housing space in such a way that, coupled to the movement of the working piston, hydraulic fluid must flow from a first region via a first connecting section into a second region. According to the invention, a switchable second connecting section is provided so as to be connected parallel to the first connecting section.

This application claims the benefit under 35 USC §119(a)-(d) of German Application No. 10 2007 014 910.9, having a filing date of Mar. 26, 2007, the entirety of which is incorporated herein by reference.

### FIELD OF THE INVENTION

The invention relates to a pressure transmission device.

### BACKGROUND OF THE INVENTION

A hydropneumatic machine tool is known from the European patent EP 0 828 942 B1. Said machine tool operates with a hydropneumatic pressure transmitter. The pressure transmitter has a stepped piston whose movement is braked toward the end of its stroke. The braked stroke is generated by means of hydraulic fluid being displaced out of a brake space which is formed during the stroke via a throttle point. In this way, damping is realized in a stroke end position in order to prevent intense noise generation, impacts and damage of a tool and a drive. Such a problem occurs in particular in the case of punching processes, since energy which is suddenly released when breaking through a material at the end of a working stroke must be intercepted.

### SUMMARY OF THE INVENTION

The invention is based on the object of providing a hydropneumatically actuated device of the type described in the introduction which can be used in a comparatively wide field of application.

The invention is based on a hydropneumatic pressure or force transmission device which comprises a working piston and a transmitter piston for pressure transmission to the working piston. The working piston is guided in a housing space in such a way that, coupled to the movement of the working piston, hydraulic fluid must flow from a first region via a first connecting section into a second region.

The essence of the invention is now that of a switchable second connecting section being provided so as to be connected parallel to the first connecting section, which second connecting section can preferably be activated and deactivated. By means of said measure, it is possible in a varied manner to control an overflow of hydraulic fluid from the first into the second region and therefore the movement of the working piston. The second connecting section is for example embodied in such a way that, in the activated state, during a movement of the working piston, hydraulic fluid can flow through largely unhindered in at least the working direction of the working piston. Once the second connecting section is activated, a movement, which is not influenced by the connecting sections, of the working piston in at least the working direction is therefore realized independently from the first connecting section for this case.

It is therefore possible for a predefined flow property of the first connecting section to be placed out of action.

A return stroke of the working piston can generally be free independently of the switching state of the second connection. The first connecting section can also permit a largely unthrottled flow in this direction.

In one particularly preferred embodiment of the invention, means are provided in order to be able to switch the second connecting section during the movement of the working piston, in particular in any position of the working piston. A controllable solenoid valve is for example provided, by means of which the second connecting section can be activated by means of a control unit. In the deactivated state, a “non-return valve” can come into effect, which blocks in the working direction and permits a flow in the return stroke direction of the working piston.

This is advantageous in particular when a throttle device is formed in the first connecting section. By activating the second connecting section, the throttle device can lose its effect, or the flow between the first and the second region can be defined in this way alone if the second connecting section is embodied as a “free flow duct”.

In an embodiment of the invention which is preferred over this, the throttle device is designed for setting a flow resistance, in particular a flow cross section, for example a constant volume flow. When the second connecting section is deactivated, it is possible in this way to provide a constant movement of the working piston with a constant volume flow independently of the force conditions in the working direction.

An abruptly falling pressure peak is for example obtained in a predefined movement section of the working piston, which pressure peak would, with a working piston being moved by a comparatively high volume flow of hydraulic fluid, cause an undesired impact in the hydropneumatic device on account of an abrupt release of pressure. If the throttle device becomes active in said region by deactivating the second connecting section, it is possible for the volume flow to be reduced such that a comparatively slow movement of the working piston with a correspondingly softer expansion characteristic is generated at the critical pressure stage.

For this purpose, the movement of the working piston is for example measured by means of a measuring system and provided to a control unit which correspondingly actuates the second movement section.

In order to obtain an even wider capability for influencing the movement of the working piston, it is also proposed that the throttle device can also be actuated for setting a throttling action, for example as a function of travel.

In an embodiment of the invention which is preferred over this, the first connecting section is also switchable, in particular can be activated and deactivated. The working piston can thereby then be “clamped” in a predefined position if the second connecting section can also be completely deactivated.

It is also possible in this way for only the second connecting section to be incorporated for defining a stroke behavior if said second connecting section operates with a predefined flow characteristic. It is for example conceivable for a throttle device to be provided in the second connecting section. Said throttle device can have different flow properties from the first throttle device.

It is also preferable if the first connecting section and/or the second connecting section are designed for a bidirectional flow.

Here, it is possible for the connecting sections in the two flow directions to operate asymmetrically, if appropriate for a flow to always be permitted in one flow direction. In the other flow direction, the flow is then preferably determined by a throttle device or the switching state of a passage.

In one particularly preferred embodiment of the invention, the first connecting section has a lower, in particular considerably lower flow resistance than the second connecting section. In addition to the first and second connecting section, it is also possible for one or more further connecting sections to be provided. The possibilities for influencing the movement can thereby be further increased.

In a further advantageous embodiment of the invention, the first region and the second region form a closed volume. It is thereby possible for the position of the working piston to be positively defined by the volume of hydraulic fluid in the first and second region.

The first and/or second region can also be embodied as an external hydraulic fluid accumulator. An external accumulator can also additionally be connected to the first and/or second region. It is also conceivable for the first and/or second region to be connected to an internal accumulator.

In order to obtain advantageous coupling of the flow of hydraulic fluid from the first into the second region to the movement of the working piston, it is also proposed that the working piston is designed such that, during a movement of the working piston, hydraulic fluid flows over from the first region into the second region or vice versa by way of displacement means which are coupled to the working piston. The displacement means comprise for example a sealed piston which is arranged in a movable fashion in a defined oil volume and which is coupled to the working piston. It is on the other hand also possible that, around a sealing point formed on the working piston, an oil volume is kept sealed off by means of further piston means arranged on the working piston. In order to displace the working piston, hydraulic fluid must flow around the sealing point into the in each case other volume region.

### BRIEF DESCRIPTION OF THE DRAWINGS

A plurality of exemplary embodiments of the invention are illustrated in the drawings and are explained in more detail below with further advantages and details being specified.

FIG. 1 shows a section along the longitudinal axis through a hydropneumatic pressure transmitter with folded stroke travel;

FIG. 2 shows the pressure transmitter from FIG. 1 in an unsectioned side view;

FIG. 3 shows a side view, tilted by 90°, of the pressure transmitter from FIG. 1 and FIG. 2 in a partial view, partially sectioned along the section line C-C in FIG. 2 with a symbolized circuit diagram;

FIGS. 4 to 7 show various embodiments of regulating blocks which are depicted in an illustration corresponding to FIG. 3 in the combination of a sectioned image with a symbolized circuit diagram, and

FIG. 8 shows a section along the longitudinal axis through an alternative hydropneumatic pressure transmitter according to the invention with a folded stroke travel.

### DETAILED DESCRIPTION OF THE INVENTION

The figures illustrate a hydropneumatic pressure transmitter 1 which has a folded travel of piston elements.

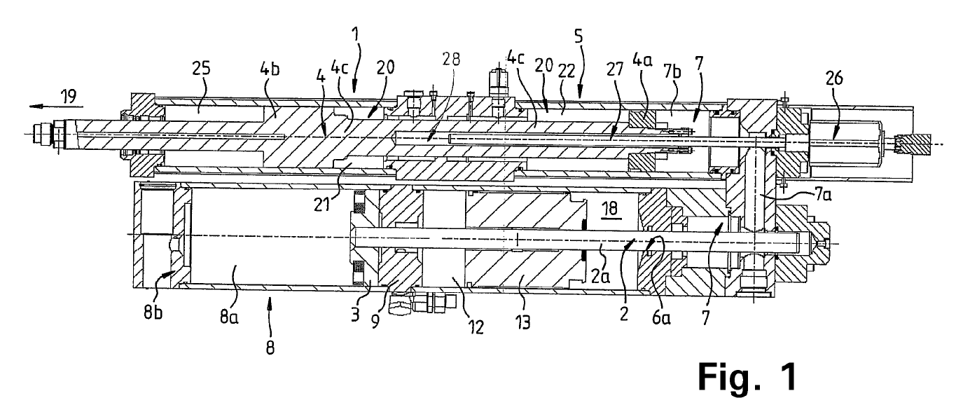

The pressure transmitter 1 comprises a pneumatically moved transmitter piston 2 (referred to below as a plunger) with a sealed piston section 3 which is arranged in a movable manner in a pneumatic space 8a of a housing section 8 of the pressure transmitter 1. FIG. 1 illustrates the fully deployed position of the plunger 2 in which a pressure transmission to a working piston 4, which moves in a parallel housing section 5, has already taken place.

In this stage, a piston rod 2a of the plunger 2 is plunged into a hydraulic high-pressure space 7 which is sealed off by the piston rod 2a by means of a seal (not illustrated). The hydraulic high-pressure space 7 extends here via a connecting line 7a into a hydraulic space section 7b in the housing section 5. The plunger is moved by pressurizing the pneumatic space 8a.

The pneumatic space 8a is sealed off by means of a wall 9 and seals (not illustrated) with respect to the piston rod 2a of the plunger to form a further pneumatic space 12.

The pneumatic space 12 is defined at one side by the wall 9 and at the other side by an accumulator piston 13.

The accumulator piston 13 has sealing elements (not illustrated) which on the one hand seal off the accumulator piston 13 in the direction of the piston rod 2a of the plunger 2 which runs through the accumulator piston 13, and on the other hand ensure a separation of the pneumatic space 12 from a hydraulic low-pressure space 18.

In the fully retracted state of the plunger 2 (FIG. 1 illustrates the fully deployed state), it is possible by means of a pneumatic movement of the accumulator piston 13 for hydraulic fluid to be pressed from the hydraulic low-pressure space 18 into the hydraulic high-pressure space 7, since the piston rod 2a is then pulled so far out of the hydraulic high-pressure space 7 that an opening 6a is opened by the seal.

As a result of a flow of hydraulic fluid into the hydraulic high-pressure space 7, the working piston 4 is moved in the working direction (see arrow 19).

The working piston 4 has a piston section 4a which is sealed off with respect to the high-pressure space 7 or 7b and a piston section 4b which is situated opposite in the working direction (arrow 19). Between the piston sections 4a and 4b, a hydraulic fluid volume is enclosed in a hydraulic space 20.

The hydraulic space 20 is divided into a first region 21 and a second region 22 by means of a seal section with respect to a piston section 4c.

A movement of the working piston 4 can therefore only take place if hydraulic fluid can flow over from the first region 21 into the second region 22 or vice versa.

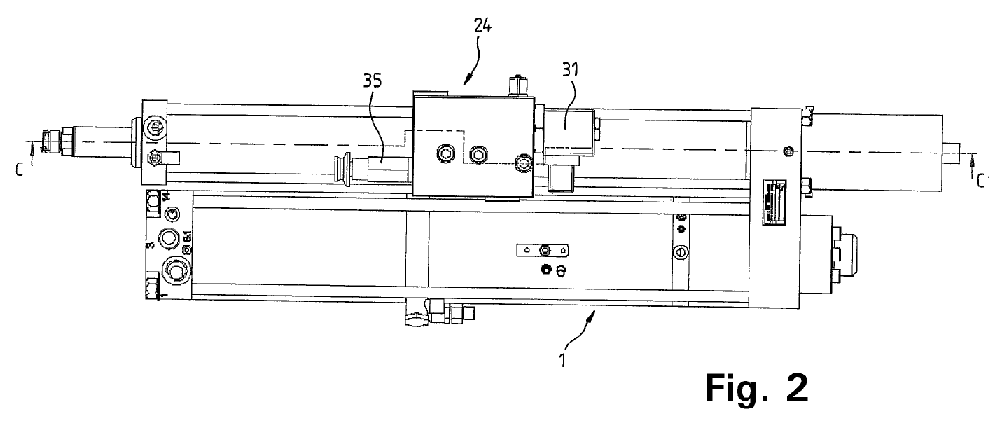

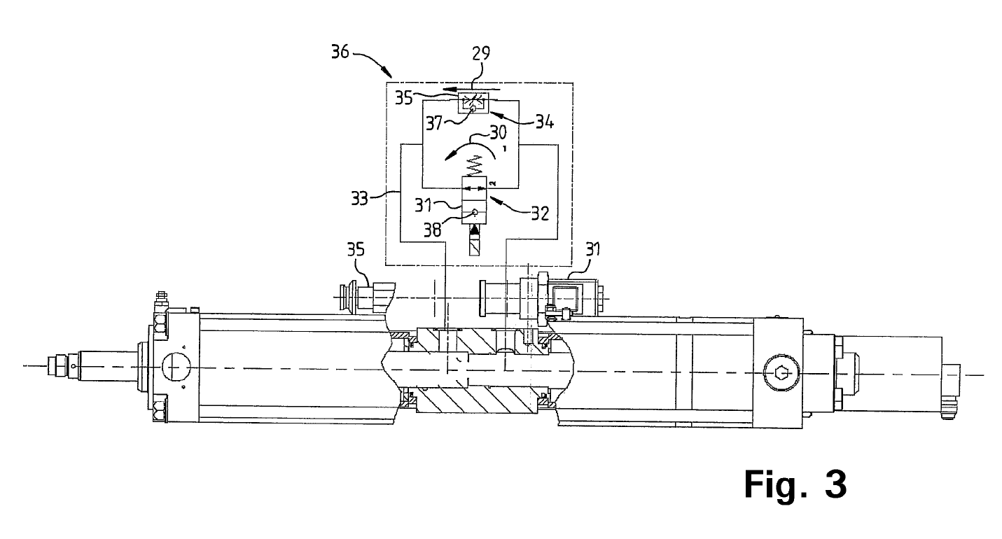

For this purpose, a regulating block 24 is provided (see FIG. 2). FIG. 2 shows a regulating block 24 which can fundamentally be formed externally or internally. FIG. 3 shows the function of said regulating block 24 in a schematically plotted block circuit diagram 36.

A movement sequence can take place as follows:

In a starting situation, the plunger 2 is fully retracted (in FIG. 1, to the left-hand bordering wall 8b of the pneumatic space 8a). Hydraulic fluid is initially displaced from the hydraulic low-pressure space 18 into the hydraulic high-pressure space 7 by means of the accumulator piston 13 which can be actuated pneumatically by means of pressurization of the pneumatic space 12. In this way, it is possible to bring about a comparatively fast stroke of the working piston 4 by means of an overflow of hydraulic fluid via the connecting line 7a into the hydraulic space section 7b (quick-action stroke).

For this purpose, the hydraulic block 24 permits for example a corresponding fast compensation of hydraulic fluid from the second region 22 into the first region 21. Some other type of regulation is however also possible.

In this phase, the working piston is under low pressure.

Beyond a predefined movement travel of the working piston 4, the latter should be acted on with high pressure. For this purpose, the piston rod 2a of the plunger 2 moves, under pneumatic loading in the pneumatic space 8a, through the opening 6a into the hydraulic high-pressure space 7. As a result of the ratio of the effective cross sections of the piston section 3 with respect to the piston rod 2a, an enormous pressure transmission into the hydraulic fluid in the hydraulic high-pressure space 7 takes place, so that the working piston can be deployed further under a large force by the highly pressurized hydraulic fluid depending on how far the plunger is plunged into the hydraulic high-pressure space 7.

During said movement, too, it is necessary for hydraulic fluid to be able to flow over from the second region 22 into the first region 21 of the hydraulic space 20. In the highly pressurized movement of the working piston, it is possible for this purpose for volume flow regulation to be initiated by means of the regulating block 24, so that the working piston 4 can, with a precisely predefined movement, carry out a working task with a high force.

On account of the fact that the working piston moves only in a defined manner and not specifically to the extent to which the working process if appropriate permits a movement travel, it is possible for impacts on the working piston 4 to be prevented in particular in the event of a breakthrough during a punching process, in which, after a large expenditure of force, at the breakthrough, a sudden release of load takes place and the working piston 4 tends to accelerate forward. By means of volume flow regulation in the regulating block 24, it is possible to predefine, in particular to shorten, an acceleration travel of said type, which leads to a considerably more uniform working behavior, in particular in punching processes with pressure release at the breakthrough or in pressing-in processes in which stick-slip effects can occur.

For a return movement of the working piston 4, the regulating block 24 can be designed such that the volume flow regulation is no longer active but rather a largely free flow of hydraulic fluid is possible from the first region 21 into the second region 22. The displacement of the hydraulic fluid between the first region 21 and the second region 22 then has no influence on the movement of the working piston 4. For the return movement, a pneumatic space 25 is acted on with compressed air and, in the same way, the plunger 2 is retracted pneumatically by means of the pneumatic space 8, so that by means of pressurization in the pneumatic space 25, hydraulic fluid can flow back from the hydraulic high-pressure space 7 into the hydraulic low-pressure space 18. In this way, the accumulator piston 13 is also moved in the direction of the wall 9.

It is self-evident that, for the working piston 4, the plunger 2 and the accumulator piston 13, a wide variety of intermediate positions are possible for different machining tasks.

In order to be able to measure a precise position of the working piston 4, a travel measuring system 26 having a measuring lance 27, which plunges into a corresponding bore 28 in the working piston 4, is provided.

As a function of the position of the working piston, it is possible for the regulating block 24 to be actuated by means of a control unit (not illustrated).

A first exemplary embodiment of the regulating block 24 is shown in FIG. 3. The regulating block 24 comprises a throttled flow path (symbolized by arrow 29) and a non-throttled flow path (shown by the arrow 30).

The flow path 30 can be activated and deactivated by means of a valve, in this case, by way of example, a solenoid valve 31. When the solenoid valve 31 is closed, in a connecting section 32, a passage 33 to the first region 21 of the hydraulic space 20 is blocked in a flow direction. In this case, only one connecting section 34 is active, which connecting section 34 contains a volume flow regulating valve 35. In the embodiment as per FIG. 3, the volume flow regulating valve 35 can be manually adjusted. It is however also conceivable to use an automatically actuable volume flow regulating valve in order to be able to continuously act on the volume flow. The volume flow regulating valve is of bidirectional design, so that hydraulic fluid can flow both from the first region 21 into the second region 22 and also in the opposite direction. Here, however, during the return flow, a flow is permitted via a parallel non-return valve 37.

When the solenoid valve 31 is open, the connecting section 32 is opened. The latter has a flow resistance which is so small in relation to the connecting section 34 that only the connecting section 32 is of importance in the direction 29. The function of the connecting section 34 is overridden, so to speak, by the activation of the connecting section 32.

The solenoid valve can be activated and deactivated at all times, so that volume flow regulation and therefore a damping behavior of the working piston 4 in the working direction 19 can be activated and deactivated in a corresponding way in any position of the working piston. For the position measurement of the working piston, it is possible for the travel measuring system 26 to be incorporated in a controller and/or regulator.

For a return flow, it is also possible, at the connecting section 32 in the deactivated state, for a non-return valve 38 to permit a free flow of hydraulic fluid.

All the pistons are preferably round pistons, and the corresponding hydraulic and pneumatic spaces are preferably cylindrical spaces. This is however not strictly necessary.

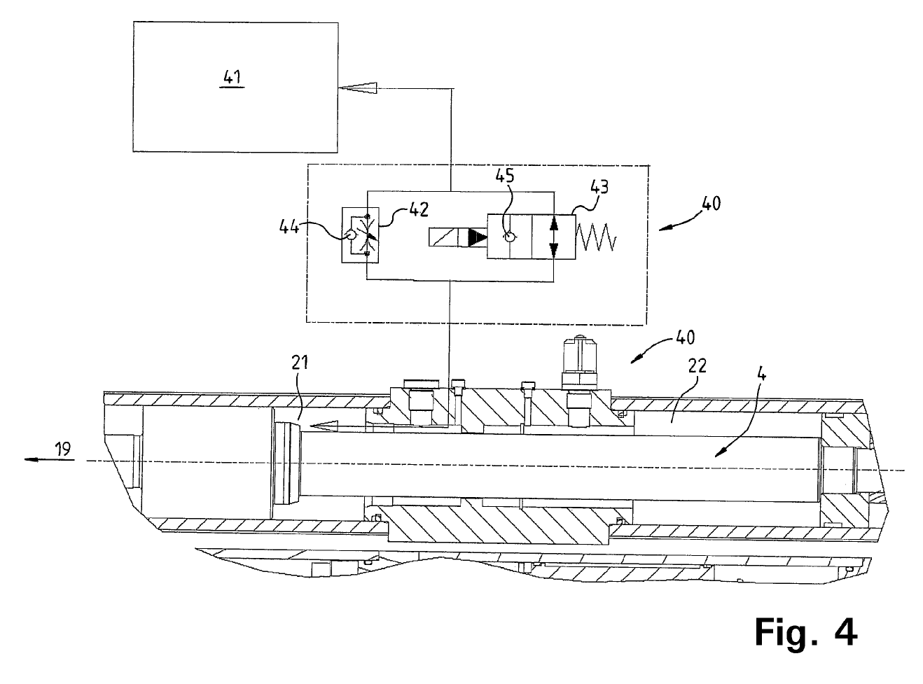

FIG. 4 illustrates a regulating block 40 in which hydraulic fluid is displaced between an external accumulator 41 and the first region 21 during a movement of the working piston 4 (symbolized by arrow). In this configuration of a regulation of the hydraulic flow, the second region 22 is embodied as a pneumatic space.

A solenoid valve 43 is provided so as to be connected parallel to a volume flow regulating valve 42. In the illustrated state of the solenoid valve 43, it is possible for hydraulic fluid to flow freely from the first region 21 into the external accumulator 41 and vice versa. A movement of the working piston is thereby not influenced significantly. The working piston 4 can also move freely in the working direction 19, since hydraulic fluid can flow freely in said direction regardless of the switching state of the solenoid valve 43 on account of the correspondingly aligned non-return valves 44 and 45. In contrast, during the return stroke, that is to say counter to the actual working direction, when the solenoid valve is activated, the volume flow regulating valve 42 comes into action, so that damping can be realized in the return stroke.

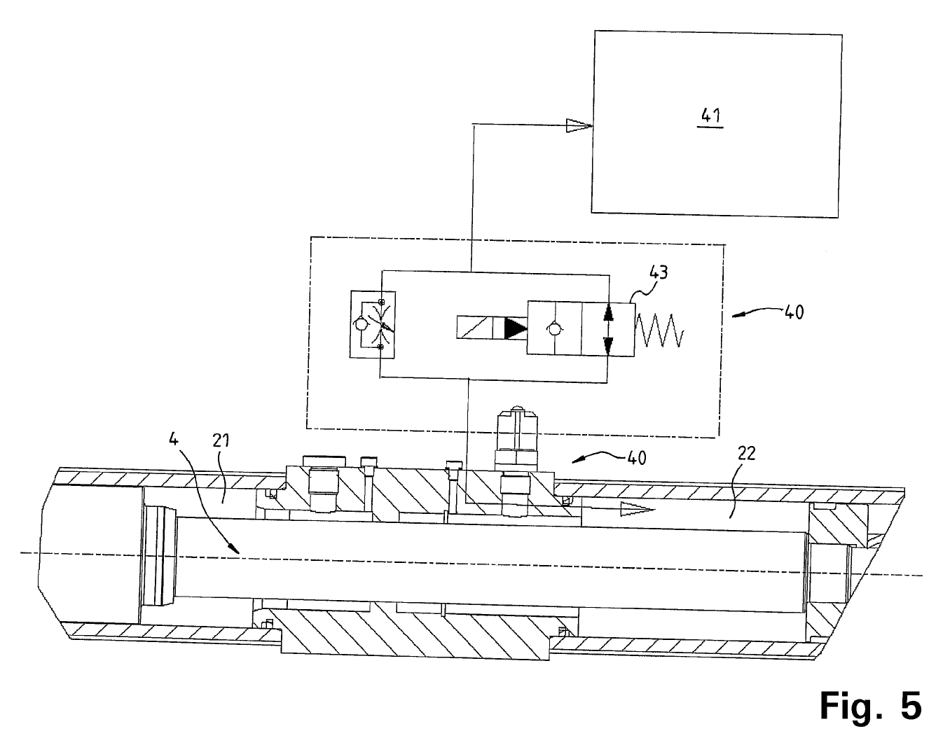

In FIG. 5, a corresponding regulating block is used. However, a connection is provided here not to the first region 21 but rather to the second region 22. The first region 21 is in this case embodied as a pneumatic space. Hydraulic fluid flows between the external accumulator 41 and the second region 22. A return stroke is therefore always directly possible, whereas a movement of the working piston 4 in the working direction with the solenoid valve 43 correspondingly activated can be carried out in a damped fashion.

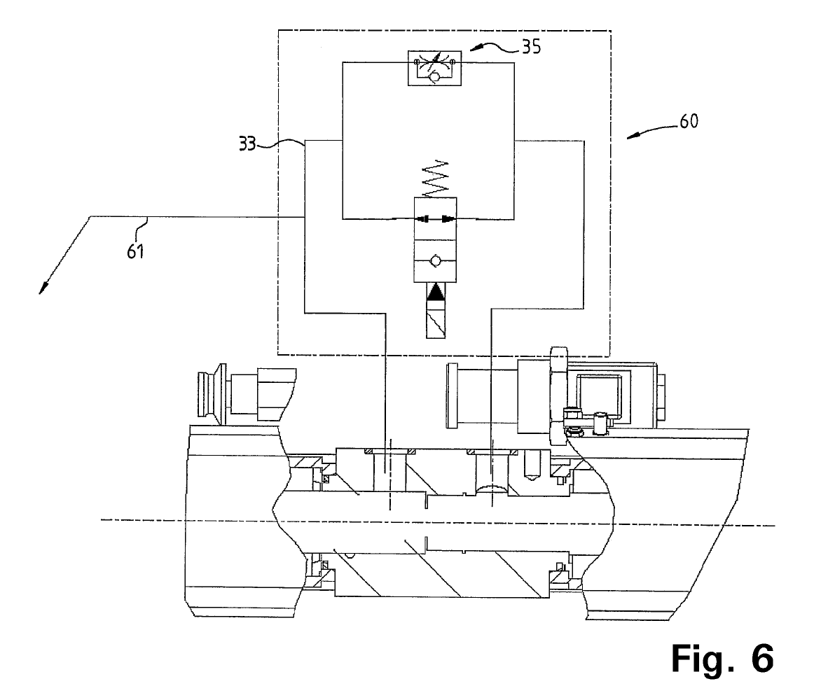

FIG. 6 shows a further circuit variant for a regulating block 60. Said embodiment corresponds to the embodiment as per FIG. 3 with the single difference that the passage 33 is connected to a compensating reservoir by means of a connecting line 61. The compensating reservoir can for example be the hydraulic low-pressure space 18 (see FIG. 1). It is essential in said embodiment that the connecting line 61 is situated on the pressure-regulated side of the flow regulating valve 35, since the oil pressure which is generated is then always in the low-pressure range.

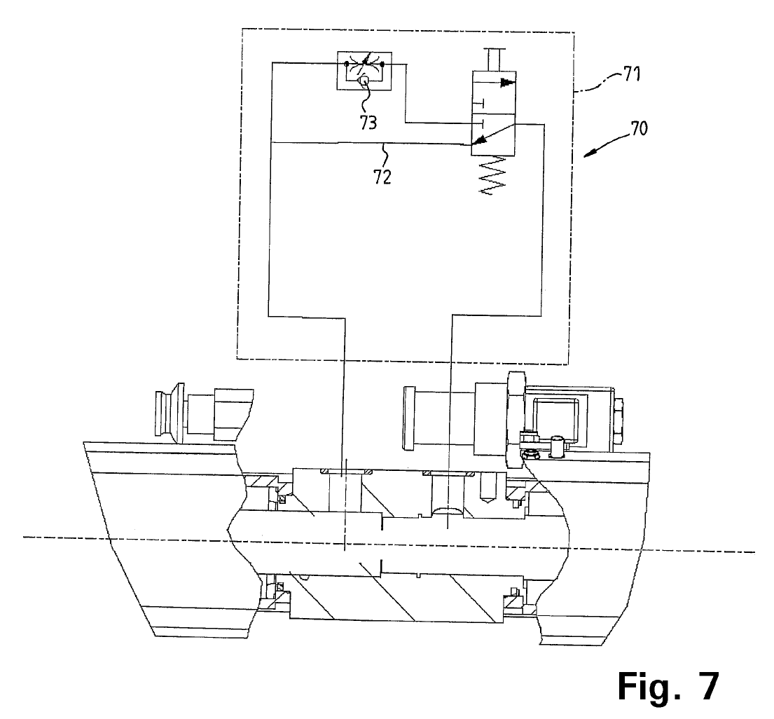

A further circuit variant is shown in FIG. 7. In said regulating block 70, it is possible for a volume flow regulating valve 71 as illustrated in the circuit diagram to be fully deactivated. In contrast, in a second switching position, a free passage 72 is fully deactivated. In the illustrated position, hydraulic fluid can flow freely between the regions. In the second switching position (not illustrated), the volume flow regulating valve 71 is active in the working direction. In the opposite direction, it is possible for hydraulic fluid to flow freely through a non-return valve 73.

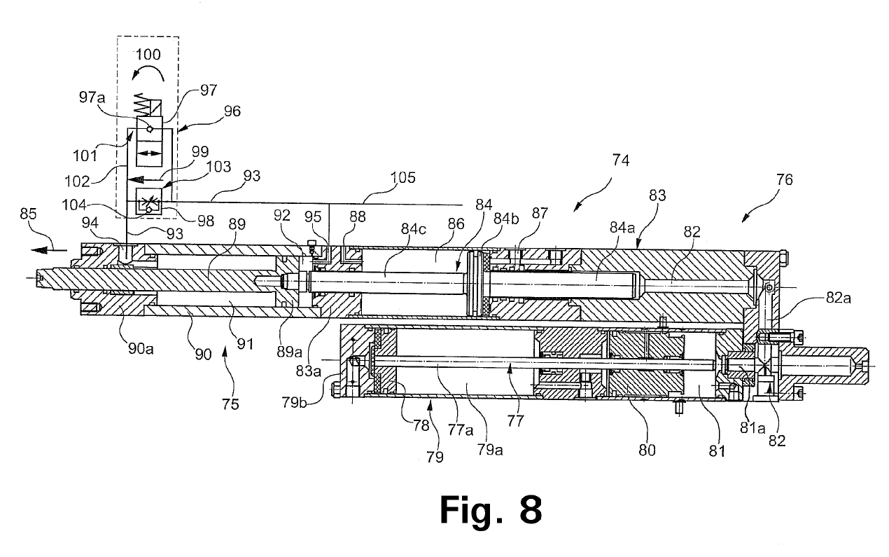

FIG. 8 shows an alternative hydropneumatic pressure transmitter 74 according to the invention, which comprises a damping unit 75 and a pneumohydraulic drive unit 76.

The damping unit 75 can for example be formed separately or installed on a known hydropneumatic pressure transmitter without damping. It is thereby for example possible in a simple manner for a hydropneumatic pressure transmitter without damping of the working stroke of the working piston to also be retrofitted or advantageously provided with damping according to the invention retroactively.

The drive unit 76 as per FIG. 8 is, in terms of its construction or the hydropneumatic basic function, constructed correspondingly to the arrangement as per FIG. 1, but without damping of the working piston in the working stroke. The damping unit 75 is provided for the damping. For the function of the drive unit 76, reference is made to the corresponding explanations with regard to the exemplary embodiment as per FIGS. 1 and 2.

The pressure transmitter 74 comprises a pneumatically moved transmitter piston 77 or plunger 77 with a piston section 78 which is guided in a housing section 79 in a sealed, movable fashion.

FIG. 8 shows the fully-retracted position of the plunger 77, before for example a quick-action stroke phase, with the piston section 78 bearing against a bordering wall 79b. The plunger 77 can be moved in a pneumatic space 79a by means of pressure loading. Also provided is an accumulator piston 80 with a passage bore through which a piston rod 77a of the plunger 77 extends.

Proceeding from the situation as per FIG. 8, in a quick-action stroke with the pneumatically generated movement of the accumulator piston 80 in the direction of an opening 81a, hydraulic fluid is displaced out of a hydraulic low-pressure space 81 via the opening 81a into a hydraulic high-pressure space 82. For the high-pressure phase, the piston section 78 is then likewise moved away from the bordering wall 79b pneumatically, so that the forward end of the piston rod 77a moves into the opening 81a and, as a result, hydraulic fluid is pressed via a connecting line 82a into the hydraulic high-pressure space 82 in a housing section 83. Here, a high pressure is built up on a working piston 84 in the housing section 83 when said working piston 84 is moved forward in the working direction as per arrow 85 counter to a resistance, for example during a pressing process.

The working piston 84 comprises a piston section 84a which plunges into a widened-diameter section of the hydraulic high-pressure space 82, a central piston section 84b which adjoins said piston section 84a, and a forward piston section 84c. The central piston section 84b is guided in a movable fashion in the housing section 83 in a sealed off fashion in a pneumatic space 86, with the forward piston section 84c extending in a sealed-off fashion through an opening in a forward housing section 83a. In the quick-action stroke and high-pressure phase, the central piston section 84b is moved in the direction of the forward housing section 83a.

The return movement of the working piston 84 after a working stroke takes place pneumatically by means of pressure loading via a return stroke connection 88 at the pneumatic space 86, which also has a pneumatic forward stroke connection 87.

The damping unit 75 serves in particular, during the working stroke, to dampen the movement of the working piston 84 or of an extension piston 89 which is fixedly connected thereto, for example in the event of a sudden intense fall in a resistance counter to the working stroke movement of the extension piston 89 in the direction of the arrow 85.

The damping unit 75 is sealingly fastened, for example by means of screws, to the front of the housing section 83a. The damping unit 75 comprises a place-on housing 90 with a forward place-on housing section 90a which is positioned opposite the housing section 83a. The extension piston 89 or the forward part, which is connected thereto, of the forward piston section 84c is accommodated in a movable fashion in the hydraulic-fluid-filled place-on housing 90. An extension piston section 89a of the extension piston 89 is movable in a sealed fashion in the place-on housing 90 and separates two damping spaces 91, 92. The extension piston 89 extends outward in a sealed fashion through the place-on housing section 90a. A tool can be held on the outer end of the extension piston 89.

For the damping of the extension piston 89 during a working stroke, the damping unit 75 is embodied as a hydraulic or for example oil-damping arrangement with a regulating block (not shown). The function of the regulating block is shown in FIG. 8 in a schematically plotted block circuit diagram 96.

Proceeding from the position as per FIG. 8, during the forward stroke or quick-action stroke and then during the working stroke of the extension piston 89, hydraulic fluid is displaced out of the second damping space 91 via a schematically shown connecting line 93 into the first damping space 92. For this purpose, the connecting line 93 connects a hydraulic duct 94 which is connected to the damping space 91 to a hydraulic duct 95 which is connected to the damping space 92.

For the damped forward movement of the extension piston 89 in the direction of arrow 85 in the working stroke and an at least substantially undamped return stroke movement counter to the direction as per arrow 85, a parallel connection of two connecting sections 101 and 103 is provided as per the block circuit diagram 96. Hydraulic fluid can pass via the connecting sections 101 and 103 from the damping space 91 into the damping space 92 and vice versa.

The connecting section 101 comprises for example a switchable solenoid valve 97 which, in the activated state, permits an unthrottled or substantially unthrottled overflow behavior of hydraulic fluid from the damping space 92 into the damping space 91 during the return stroke of the extension piston 89, with the non-throttled flow path being indicated by the arrow 100. Instead of the solenoid valve 97, it is also possible for some other switchable valve to be used. Also integrated in the solenoid valve 97 is a non-return valve 97a. The non-return valve 97a need not strictly be accommodated in the solenoid valve 97. The non-return valve 97a can alternatively also be formed for example in a bypass in the extension piston section 89a.

Instead of the function of the regulating block shown as per the block circuit diagram 96, pneumatic and/or hydraulic actuation is alternatively also conceivable.

In addition, a volume flow regulating valve 98 is provided in the connecting section 103, by means of which volume flow regulating valve 98 a throttled flow path (symbolized by arrow 99) is realized during the working stroke for the overflow of hydraulic fluid from the damping space 91 into the damping space 92.

It is fundamentally also possible for some other device to be provided instead of the volume flow regulating valve 98 in order to influence the volume which can flow through the connecting section 103. It is for example possible for a throttle, a proportional throttle, a proportional flow regulating valve or a proportional directional control valve to be.

The mode of operation as per the block circuit diagram 96 corresponds to the block circuit diagram 36 as per FIG. 3.

The flow path 100 can be activated and deactivated by means of the solenoid valve 97. When the solenoid valve 97 is closed, in the connecting section 101, a passage 102 to the damping space 92 is blocked in a flow direction. In this case, only the connecting section 103 is active, which connecting section 103 contains the volume flow regulating valve 98. The volume flow regulating valve 98 can be adjusted in a manually or automatically actuable fashion in order, for example, to be able to continuously influence the volume flow. The volume flow regulating valve 98 is for example of bidirectional design, so that hydraulic fluid can flow both from the damping space 91 to the damping space 92 and vice versa. Here, however, during the return flow, a flow is permitted via a parallel non-return valve 104.

When the solenoid valve 97 is open, for the return stroke of the extension piston 89, the connecting section 101 is opened. Here, too, as in the regulating block 36, the connecting section 101 has a flow resistance which is so small in relation to the connecting section 103 that only the connecting section 103 is of importance in the direction 99. Here, the function of the connecting section 103 is, so to speak, overridden by activating the connecting section 101.

Conversely, during the forward stroke or working stroke of the extension piston 89, the solenoid valve 97 is closed, so that a passage via the connecting section 101 is not possible and hydraulic fluid can pass from the damping space 91 into the damping space 92 only via the volume flow regulating valve 98, which takes place with an adjustable maximum volume flow, which is however considerably lower than the maximum volume flow through the connecting section 101 when the solenoid valve is open.

The connecting line 93 can form a closed line circuit or can be connected via a connecting line 105 for example to a hydraulic fluid accumulator (not shown) or to the hydraulic low-pressure space 81.

By means of the approach according to the invention, it is possible to realize a hydropneumatic device which offers numerous advantages. Firstly, as already described, shock-free punching and pressing in are possible. Here, by means of corresponding regulation, a pressing-in speed in the working direction is adjustable. In addition, it is possible to realize soft setting-down of a working piston on a component. By means of corresponding regulation, it is possible for the speed of the working piston in an energyless state to be adjusted by means of a regulating unit in such a way that an impact prevention arrangement, for example in the case of pressing, is no longer necessary. Since a regulating intervention is possible over the entire stroke of the working piston, it is for example conceivable for the working piston to be moved with a predefined speed profile.

### LIST OF REFERENCE SYMBOLS

1 Hydropneumatic pressure transmitter
2 Transmitter piston (plunger)
2a Piston rod
3 Piston section
4 Working piston
4a Piston section
4b Piston section
4c Piston section
5 Housing section
6a Opening
7 Hydraulic high-pressure space
7a Connecting line
7b Hydraulic space section
8 Housing section
8a Pneumatic space
8b Bordering wall
9 Wall
12 Pneumatic space
13 Accumulator piston
18 Hydraulic low-pressure space
19 Arrow
20 Hydraulic space
21 First region
22 Second region
24 Regulating block
25 Pneumatic space
26 Travel measuring system
27 Measuring lance
28 Bore
29 Arrow
30 Arrow
31 Solenoid valve
32 Connecting section
33 Passage
34 Connecting section
35 Volume flow regulating valve
36 Block circuit diagram
37 Non-return valve
38 Non-return valve
40 Regulating block
41 External accumulator
42 Volume flow regulating valve
43 Solenoid valve
44 Non-return valve
45 Non-return valve
60 Regulating block
61 Connecting line
70 Regulating block
71 Volume flow regulating valve
72 Free passage
73 Non-return valve
74 Pressure transmitter
75 Damping unit
76 Drive unit
77 Transmitter piston
77a Piston rod
78 Piston section
79 Housing section
79a Pneumatic space
79b Bordering wall
80 Accumulator piston
81 Hydraulic low-pressure space
81a Opening
82 Hydraulic high-pressure space
82a Connecting line
83 Housing section
83a Housing section
νWorking piston
84a Piston section
84b Piston section
84c Piston section
85 Arrow
86 Pneumatic space
87 Forward stroke connection
88 Return stroke connection
89 Extension piston
89a Extension piston section
90 Place-on housing
90a Place-on housing section
91 Damping space
92 Damping space
93 Connecting line
94 Hydraulic duct
95 Hydraulic duct
96 Block circuit diagram
97 Solenoid valve
97a Non-return valve
98 Volume flow regulating valve
99 Arrow
100 Arrow
101 Connecting section
102 Passage
103 Connecting section
104 Non-return valve
105 Connecting line

We claim:

1. A hydropneumatic pressure transmission device having a working piston and a transmitter piston for pressure transmission to the working piston, with the working piston being guided in a housing space in such a way that, coupled to the movement of the working piston, hydraulic fluid must flow from a first region via a first connecting section into a second region, wherein a switchable second connecting section is provided so as to be connected parallel to the first connecting section.

2. The device according to claim 1, wherein means are provided in order to be able to switch the second connecting section during the movement of the working piston.

3. The device according to claim 1, wherein the first connecting section comprises a throttle device.

4. The device according to claim 3, wherein the throttle device is designed for setting a constant volume flow.

5. The device according to claim 3, wherein the throttle device can be actuated for setting the throttling action.

6. The device according to claim 1, wherein the first connecting section can be activated and deactivated.

7. The device according to claim 1, wherein the first connecting section is designed for a bidirectional flow.

8. The device according to claim 1, wherein the second connecting section is designed for a bidirectional flow.

9. The device according to claim 1, wherein the first connecting section has a lower, in particular considerably lower flow resistance than the second connecting section.

10. The device according to claim 1, further comprising connecting sections which are connected in parallel.

11. The device according to claim 1, wherein the first region and the second region form a closed volume.

12. The device according to claim 1, wherein the working piston in the housing is designed such that, by means of a movement of the working piston, hydraulic fluid flows over from the first region into the second region and vice versa by way of displacement means which are coupled to the working piston.

13. A working machine having a device according to claim 1.

14. A machine tool having a device according to claim 1.
